(19) United States
(12) Patent Application Publication
(10) Pub. No.: US 2013/0086956 A1
(43) Pub. Date: Apr. 11, 2013

(54) MULTIPLE MODE LOCKING ARRANGEMENTS

(71) Applicant: Master Lock Company LLC, Oak Creek, WI (US)

(72) Inventor: Zachery T. Nave, Oak Creek, WI (US)

(73) Assignee: MASTER LOCK COMPANY LLC, Oak Creek, WI (US)

(21) Appl. No.: 13/630,115

(22) Filed: Sep. 28, 2012

Related U.S. Application Data
(60) Provisional application No. 61/541,132, filed on Sep. 30, 2011.

(51) Int. Cl. E05B 67/00

(52) U.S. Cl. CPC E05B 67/00
USPC 70/20

(57) ABSTRACT

A lock includes a lock body, an access restricting structure, a locking mechanism, a lock interface, and a mode selection mechanism. The locking mechanism is operable to secure the access restricting structure in a first position when the locking mechanism is in a locked condition. The lock interface is operable to move the locking mechanism between the locked condition and an unlocked condition. The mode selection mechanism is operable to selectively place the locking mechanism in either one of a first mode and a second mode. In the first mode, movement of the access restricting structure to the first position automatically moves the locking mechanism to the locked condition. In the second mode, the access restricting structure is movable to the first position without moving the locking mechanism to the locked condition.

### CROSS-REFERENCE TO RELATED APPLICATION

This application claims the benefit of U.S. Provisional Patent Application Ser. No. 61/541,132, entitled “MULTIPLE MODE LOCKING ARRANGEMENTS” and filed Sep. 30, 2011, the entire disclosure of which is incorporated herein by reference, to the extent that it is not conflicting with the present application.

### BACKGROUND

Security devices, such as padlocks and other types of conventional locks, are used, for example, to prevent access to a room, building, enclosure, container, or piece of equipment. Exemplary padlocks include those opened by a key and those opened by manipulation of lock components in accordance with a unique combination. In a conventional padlock, a shackle is secured within a lock body by one or more internal locking members that are received in corresponding notches in the shackle to prevent axial withdrawal of the shackle from the lock body. Proper manipulation of a locking mechanism, such as rotation of a key cylinder with an authorized key, rotation of one or more combination dials to a desired orientation, or energizing of an electromechanical mechanism by an electric authorization signal, moves a cam or blocker inside the padlock to a position allowing the locking members to disengage from the corresponding shackle notches. This allows the shackle to be withdrawn from the lock body, either manually or automatically (e.g., by a spring-loaded mechanism).

In some such padlocks, the shackle may be automatically relocked without the key when returned to the closed position. When the notches of the shackle are re-aligned with the locking members, a spring-loaded mechanism of the cam/blocker forces the locking members back into engagement with the shackle notches to lockingly secure the closed shackle. In some applications, however, it may be desirable to limit the ability to re-lock the padlock to authorized users of the lock. For example, in some equipment safety lockout applications, unauthorized or inadvertent locking out of the equipment may present a safety hazard. Some key-operated padlocks are provided with a key-retaining feature, by which the padlock shackle must be re-closed to allow the key to be rotated back to an orientation in which the key may be removed from the lock. In some applications, it may not be desirable to keep the key with the unlocked lock.

### SUMMARY

According to an exemplary aspect of the present application, a locking mechanism is configured to be operable in two or more modes to provide different lock functionality based on the selected mode of the locking mechanism. Examples of different modes or lock functionality include automatic locking vs. locking only upon authorized user input; operation using different mechanical keys or lock interfaces; and operation of different access restricting structures. Accordingly, in an exemplary embodiment, a multiple mode locking mechanism includes a latch, a user operable lock interface, and a mode selection mechanism. The user operable lock interface is operable in a first mode to selectively move the latch to provide a first lock condition, and operable in a second mode to selectively move the latch to provide a second lock condition. The mode selection mechanism is operable to place the lock interface in a selected one of the first and second modes.

According to another exemplary aspect of the present application, a lock may be configured to operate in either an automatic locking mode (e.g., a padlock that automatically locks the shackle when the shackle is pushed closed) or a selective locking mode (e.g., a padlock that requires an authorized user operation to lock the closed shackle). Accordingly, in an exemplary embodiment, a lock includes a lock body, an access restricting structure, a locking mechanism, a lock interface, and a mode selection mechanism. The locking mechanism is operable to secure the access restricting structure in a first position when the locking mechanism is in a locked condition. The lock interface is operable to move the locking mechanism between the locked condition and an unlocked condition. The mode selection mechanism is operable to selectively place the locking mechanism in either one of a first mode and a second mode. In the first mode, movement of the access restricting structure to the first position automatically moves the locking mechanism to the locked condition. In the second mode, the access restricting structure is movable to the first position without moving the locking mechanism to the locked condition. According to still another exemplary aspect of the present application, a padlock may be provided with a sliding blocker and a rotatable latch configured to provide a desired lock function. For example, the latch may be configured such that the shackle automatically locks (e.g., is secured against vertical sliding movement) when moved to either one of the open and closed positions, automatically locks when moved to the closed position but remains unlocked when moved to the open position, or remains unlocked when moved to either one of the open and closed positions. Accordingly, in an exemplary embodiment, a padlock includes a lock body, a shackle, a blocker, a latch, a user operable lock interface, and a linking member. The shackle is assembled with the lock body and movable with respect to the lock body between a closed position and an open position. The blocker is disposed within the lock body and movable between a blocking position in which the blocker secures a locking member in interlocking engagement with a first notch of the shackle when the shackle is in the closed position and with a second notch of the shackle when the shackle is in the open position, and a releasing position in which the blocker permits disengagement of the locking member from the corresponding one of the first and second notches for movement of the shackle between the closed position and the open position. The latch is disposed in the lock body and is rotatable between a first locking position in which the latch blocks movement of the blocker from the blocking position to the releasing position, and a first unlocking position in which a first recess portion of the latch aligns with the blocker to permit movement of the blocker from the blocking position to the releasing position. The lock interface is assembled with the lock body and is operable in a first mode to selectively rotate the latch between the first locking position and the first unlocking position. The linking member is separably connected between the blocker and the latch. When the latch is in the first unlocking position and the shackle is moved to the open position, movement of the blocker to the blocking position causes the linking member to rotate the latch to a second unlocking position in which a second recess portion in the latch aligns with the blocker to permit movement of the blocker from the blocking position to the releasing position. When the latch is in the second unlocking position and the shackle is moved to the closed position, movement of the blocker to the blocking position causes the linking member to rotate the latch to the first locking position.

According to another exemplary aspect of the present application, a method may be utilized to operate a locking mechanism in a selected one of first and second lock modes, the locking mechanism including a latch operable between a locked position and an unlocked position and an access restricting structure movable between a first position and a second position. In an exemplary method, a mode selection mechanism is operated to selectively place the locking mechanism in a selected one of the first and second modes; and the access restricting structure is moved from the first position to the second position. When the locking mechanism is in the first mode, moving the access restricting structure to the second position automatically moves the latch to the locked condition to secure the access restricting structure in the second position. When the locking mechanism is in the second mode, movement of the access restricting structure to the first position does not move the latch to the locked position.

### BRIEF DESCRIPTION OF THE DRAWINGS

Features and advantages of the invention will become apparent from the following detailed description made with reference to the accompanying drawings, wherein:

FIG. 1A is a schematic cross-sectional view of an exemplary padlock operable in an unlocked open and closed mode, shown in a locked condition;

FIG. 1B is a schematic cross-sectional view of the padlock of FIG. 1A, shown in an unlocked condition;

FIG. 2 is an exploded perspective view of an exemplary padlock operable in an unlocked open and closed mode;

FIGS. 2A, 2B, and 2C are front views of the padlock of FIG. 2, shown in various operating conditions with the front body plate removed;

FIGS. 3A, 3B, and 3C are rear cross-sectional views of the padlock of FIG. 2, shown in corresponding operating conditions;

FIG. 3D is a partial cross-sectional view of the motor, gear, and latch member of the padlock of FIG. 2;

FIG. 4A is a schematic cross-sectional view of an exemplary padlock operable in an automatic locking open and closed mode, shown in a locked condition;

FIG. 4B is a schematic cross-sectional view of the padlock of FIG. 4A, shown in an unlocked condition;

FIG. 5 is an exploded perspective view of an exemplary padlock operable in an automatic locking open and closed mode;

FIGS. 5A, 5B, 5C, 5D, 5E, and 5F are front views of the padlock of FIG. 5, shown in various operating conditions with the front body plate removed;

FIGS. 6A, 6B, 6C, 6D, 6E, and 6F are rear cross-sectional views of the padlock of FIG. 5, shown in corresponding operating conditions;

FIG. 6G is a perspective view of the blocker, linking member, and latch member of the padlock of FIG. 5;

FIG. 7A is a schematic cross-sectional view of an exemplary padlock operable in an automatic locking closed mode, shown in a locked condition;

FIG. 7B is a schematic cross-sectional view of the padlock of FIG. 7A, shown in an unlocked condition;

FIG. 7C is a schematic cross-sectional view of the padlock of FIG. 7A, shown in an unlocked and open condition;

FIG. 8 is an exploded perspective view of an exemplary padlock operable in an automatic locking closed mode;

FIGS. 8A, 8B, 8C, 8D, and 8E are front views of the padlock of FIG. 8, shown in various operating conditions with the front body plate removed;

FIGS. 9A, 9B, 9C, 9D, and 9E are rear cross-sectional views of the padlock of FIG. 8, shown in corresponding operating conditions;

FIG. 10A is a schematic cross-sectional view of an exemplary multiple mode padlock, configured for operation in a first mode and shown in an unlocked condition;

FIG. 10B is a schematic cross-sectional view of the padlock of FIG. 10A, configured for operation in a second mode and shown in an unlocked condition;

FIG. 11 is an exploded perspective view of an exemplary padlock operable in multiple operating modes;

FIGS. 11A and 11B are front and rear views of the padlock of FIG. 10, with the lock body omitted to illustrate additional features of the padlock; and

FIG. 12 is a perspective view of the latch member of the padlock of FIGS. 11A and 11B.

### DETAILED DESCRIPTION

This Detailed Description merely describes embodiments of the invention and is not intended to limit the scope of the application in any way. Indeed, the invention is broader than and unlimited by the preferred embodiments, and the terms used have their full ordinary meaning.

Also, while the exemplary embodiments described in the specification and illustrated in the drawings relate to an electronic remote operated padlock, it should be understood that many of the inventive features described herein may be applied to other types of electronic padlocks, including, for example, keypad operated or biometric (e.g., fingerprint scan, voice recognition) padlocks, as well as other types of locking devices, including, for example, safes, lock boxes, cable locks, and door locks. Still other inventive features described herein may apply to purely mechanical locking mechanisms, including, for example, key operated or combination dial padlocks. Many of the inventive features described herein may additionally or alternatively be utilized with other types of locks, including, for example, door locks, locker locks, cable locks, and safety lockout devices.

The present application contemplates, in part, a locking mechanism for a lock (e.g., a padlock) that functions in a desired operating mode. According to an exemplary aspect of the present application, a locking mechanism may be configured to be placed in a selected one of two or more operating modes, such that the locking mechanism operates in accordance with a desired functionality. For example, a locking mechanism may be placed in a first mode in which the locking mechanism is configured to automatically lock an access restricting structure when it is moved to a first position (e.g., automatically lock a shackle when it is pushed closed). The exemplary locking mechanism may alternatively be placed in a second mode in which the access restricting structure remains unlocked when it is moved to the first position, and must be selectively locked in response to an authorized user input (e.g., key insertion, keypad entry). As another example, a locking mechanism may be placed in a first mode in which the locking mechanism is unlocked using a first lock input (e.g., first key), or in a second mode in which the locking mechanism is unlocked using a second lock input (e.g., second key). As still another example, a locking mechanism may be placed in a first mode in which the locking mechanism is operable to unlock a first access restricting structure (e.g., shackle or door), or in a second mode in which the locking mechanism is operable to unlock a second access restricting structure (e.g., shackle or door).

In one such exemplary mode, proper manipulation of a lock interface is required to unlock the lock and to relock the lock after an access restricting structure (e.g., a shackle, door, etc.) is returned to the closed condition. In this “unlocked open and closed” mode, the access restricting structure is freely movable between open (or access granting) and closed (or access restricting) positions when unlocked. In another exemplary mode, proper manipulation of a lock interface is required both to unlock the lock and to return the access restricting structure to a closed and locked condition. In this “automatic locking open and closed” mode, the access restricting structure is automatically secured when moved to either closed or open positions. In still another exemplary mode, an “automatic locking closed” mode, proper manipulation of a lock interface is only required to open the lock, with the lock automatically re-locking when the access restricting structure is returned to a closed or access restricting condition.

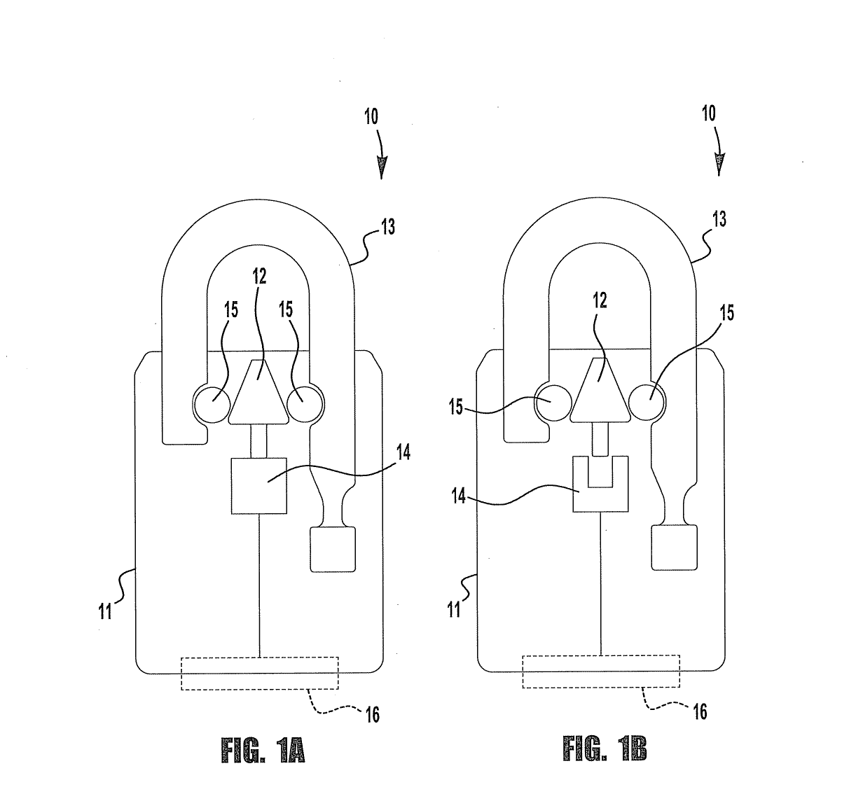

In an exemplary embodiment, a padlock may be configured to operate in an unlocked open and closed mode, as described above. Many different locking mechanisms may be utilized to provide an unlocked open and closed mode. In one such exemplary embodiment, as shown schematically in FIGS. 1A and 1B, a padlock 10 includes a blocker 12 within the lock housing 11 that holds locking members 15 in interlocking engagement with corresponding notches in the padlock shackle 13 when in a shackle engaging condition, and permits disengagement of the locking members from the shackle notches in shackle disengaging condition to permit withdrawal or opening of the shackle. A blocker securing latch member 14 is movable between a locked condition (FIG. 1A) in which the latch member blocks movement of the blocker 12 toward the shackle disengaging condition, and an unlocked condition (FIG. 1B) in which the latch member permits movement of the blocker 12 to the shackle disengaging condition. The latch member 14 may include a suitable arrangement or mechanism to selectively obstruct or permit movement of the blocker 12, including, for example, a rotational or rotary locking component, a pivoting locking component, or a sliding locking component. Proper manipulation of a lock interface 16 moves the latch member 14 from the locked condition to the unlocked condition, upon which the shackle 13 may be manually pulled to an open position or automatically moved to the open position (e.g., by a spring biasing mechanism). With the latch member 14 in the unlocked position, the shackle 13 may be moved freely between open and closed positions. When the shackle has been returned to the closed position, proper manipulation of the lock interface 16 (which may, but need not, be the same as the manipulation used to unlock the padlock) returns the latch member to the locked condition to secure the shackle 13 in the closed position.

Any suitable lock interface 16 may be utilized for operation of the lock 10, including for example, a mechanical key or combination dial mechanism, or an electromechanical interface, in which a motor or other such electromechanical actuator is utilized to drive the latch member in response to receiving an electrical authorization signal, generated in response to proper manipulation of the lock interface. Any suitable electronic lock interface may be utilized, including, for example, electronic key pad, electronic key card, biometric scanner (e.g., fingerprint, voice recognition, or retinal scan), wireless signal transmission (e.g., infrared, radio, near field communication, Bluetooth communication, 802.11, WiMAX, etc.), or other suitable arrangements.

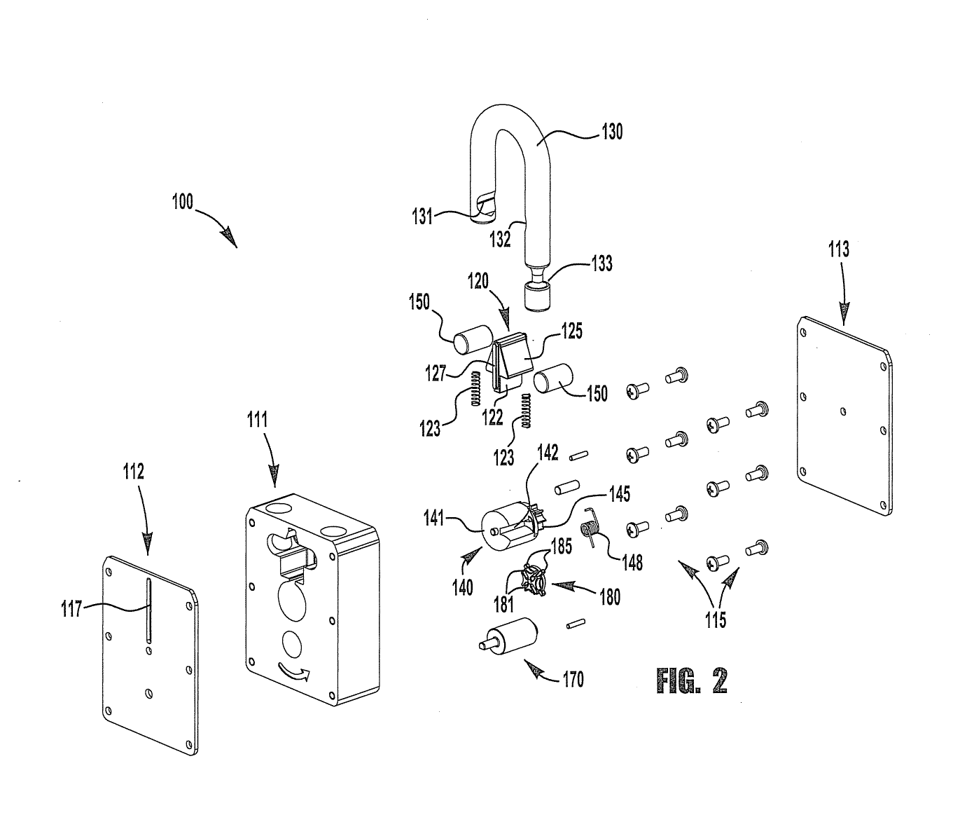

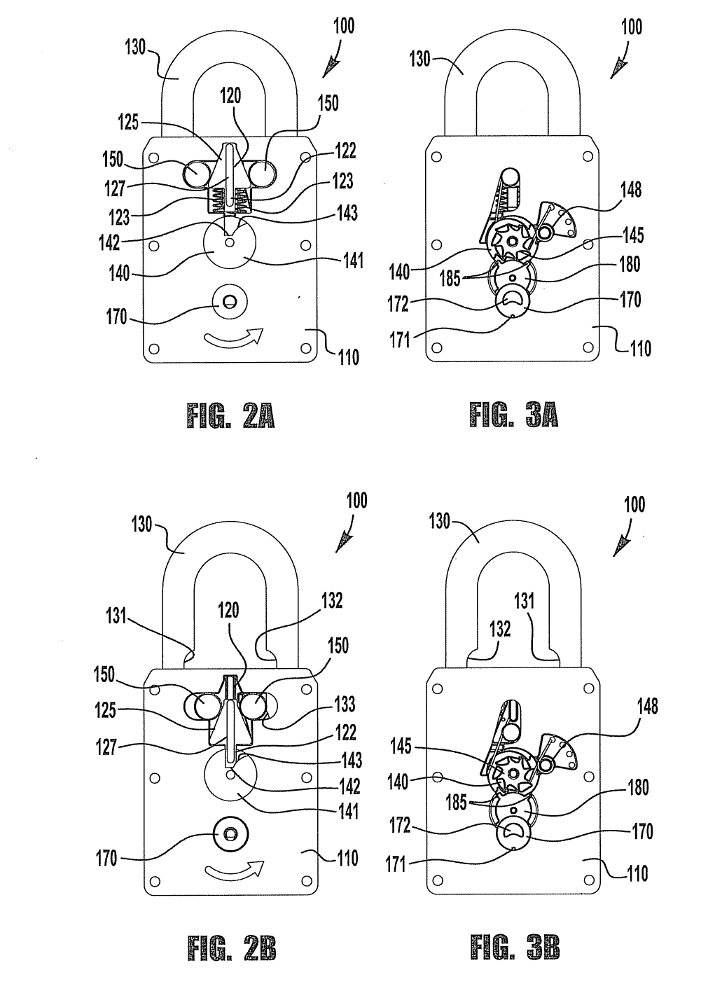

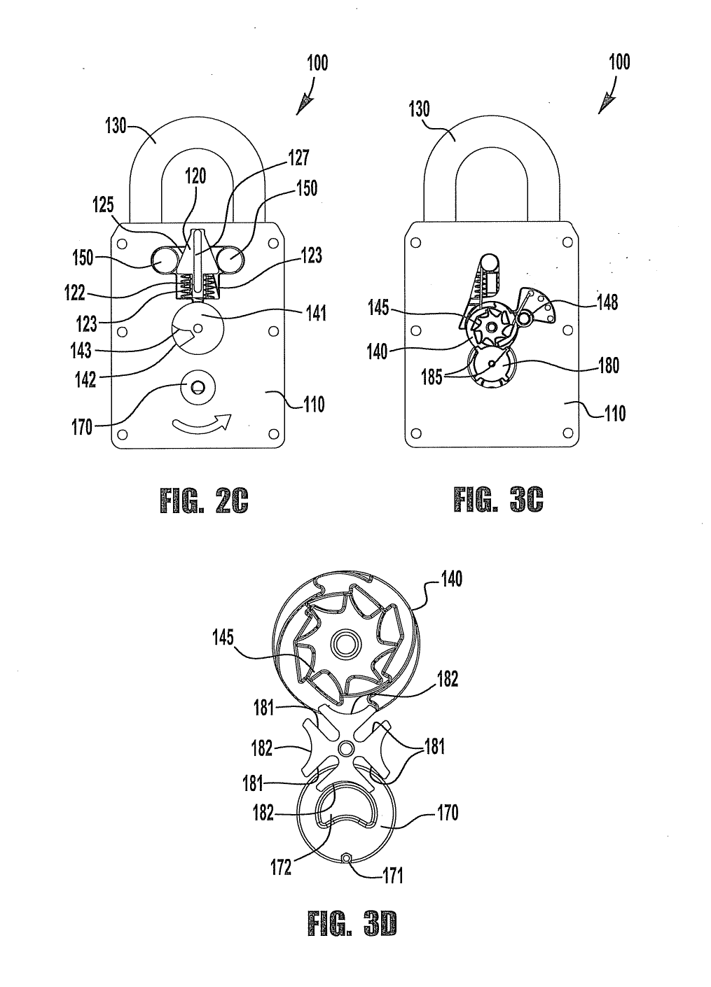

FIGS. 2, 2A-2C, and 3A-3C illustrate partial cross-sectional front and rear views of an exemplary padlock 100 with a locking mechanism providing for an unlocked open and closed mode, as described above. The padlock 100 includes a lock body 110 that retains a shackle 130 and receives internal locking components within cavities defined by a body block 111 and front and rear plates 112, 113 secured to the body block 111 by fasteners 115. The padlock locking mechanism includes a sliding blocker 120 spring-biased (by springs 123) toward a shackle engaging position (FIGS. 2A and 2C), in which a wide portion of the blocker holds locking pins 150 in interlocking engagement with shackle notches 131, 132. As shown, the blocker 120 may include a rib 127 or other such projection receivable within a slot 117 in the front plate 112 of the lock body 110, to guide vertical movement of the blocker 120. A rotary latch member 140 includes an outer peripheral or raised locking portion 141 that aligns with a blocker extension 122 to secure the blocker 120 in the shackle engaging position when the rotary latch member 140 is in a locked position. The rotary latch member further includes a recessed unlocking portion 142 that aligns with the blocker extension 122 to permit movement of the blocker 120 from the shackle engaging position to a shackle disengaging position when the rotary latch member 140 is rotated to an unlocked position (see FIGS. 2A and 2B). In the shackle disengaging position, upward movement of the shackle 130 causes the locking pins 150 to force the blocker extension 122 downward into the recessed portion 142 of the rotary latch 140, causing the locking pins 150 to disengage from the shackle notches 131, 132 for release of the shackle 130. When the shackle is returned to the closed position, an end portion 133 (FIG. 2B) of the long shackle leg drives the corresponding locking pin 150 against the tapered blocker surface 125 to move the blocker 120 to the shackle disengaging position. This arrangement allows the locking pins 150 to re-align with the shackle notches 131, 132, at which point the spring-biased blocker 120 automatically returns to the shackle engaging position.

To lock the padlock 100, the rotary latch member 140 is rotated a predetermined angle (e.g., 90-180 degrees, 120-150 degrees, or approximately 135 degrees) corresponding to the rotational distance between the unlocking portion 142 and locking portion 141 of the latch member 140, to align the locking portion 141 of the latch member with the blocker extension 122, thereby securing the blocker in the shackle engaging position (see FIG. 2C). To help urge the blocker 120 back to the shackle engaging position, an end surface 143 of the recessed portion 142 of the latch member 140 may be contoured for guiding engagement with the blocker extension 122. While any suitable mechanism may be utilized to rotate the latch member 140, in the illustrated embodiment, as shown in FIGS. 3A-C, a rotary lock element 170 drives a gear 180, which in turn drives the latch member 140. In one embodiment, the rotary lock element 170 includes a motor that receives an electric authorization signal (e.g., from an electronic lock interface, not shown) to operate the motor 170 for rotating the latch member (via gear 180) between locked and unlocked positions. To unlock the padlock 100, the rotary locking element 170 may similarly be operated to advance the latch member 140 a predetermined angle (e.g., 180-270 degrees, 210-240 degrees, or approximately 225 degrees) corresponding to the rotational distance between the locking portion 141 and the unlocking portion 142 of the latch member 140, to orient the latch member in the unlocked position. The padlock 100 may be configured to be lockable by user manipulation of the lock interface when the shackle 130 is in either the open or closed position. Alternatively, the padlock 100 may be configured to prevent the shackle 130 from being locked in the closed position, for example, by employing switches or other sensors (not shown) that provide a signal when the shackle is in the open position to disable or otherwise prevent operation of the latch member.

As shown, the latch member 140, gear 180, and rotary lock element 170 may be configured for unidirectional rotation, with the latch member 140 utilizing a star wheel gear portion 145 that is drivingly engaged by an outer peripheral tooth 185 of the gear 180 in only a forward rotational direction, and a torsion spring element 148 to impede reverse rotation of the latch member 140. Further, to prevent unauthorized rotation of the gear 180, the rotary lock element 170 and gear 180 may be provided with a Geneva cam type arrangement to secure the gear 180 against rotation when the rotary locking element 170 is in a non-actuating position, in which a blocking projection 172 obstructs rotation of the gear 180. In one such arrangement, as shown in the partial cross-sectional view of FIG. 3D, an extension pin 171 extending from the motor 170 moves into a radial slot 181 in the gear 180 to engage and rotate the gear 180 in predetermined angular increments (e.g., 44-135 degree, 75-105 degree, or approximately 90 degree increments). At the end of the rotational increment, the pin 171 is withdrawn from the slot 181, and the crescent shaped projection 172 on the motor 170 engages a corresponding recess 182 in the gear 180 to block rotation of the gear. Continued rotation of the motor 170 engages the pin 171 with an adjacent slot 181 in the gear 180 to rotate the gear an additional predetermined angular increment (e.g., 44-135 degree, 75-105 degree, or approximately 90 degree increment).

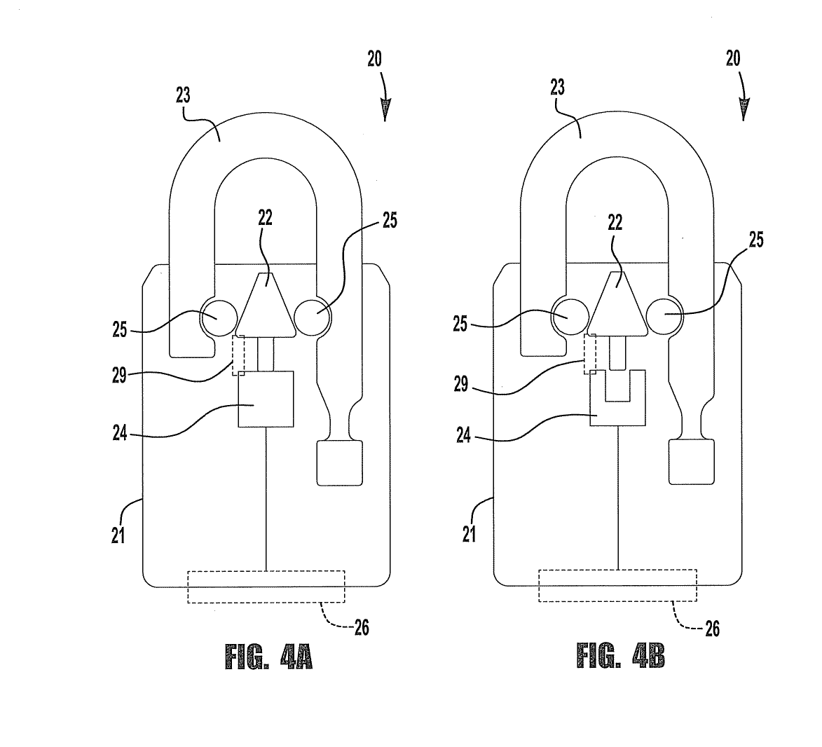

In another exemplary embodiment, a padlock may be configured to operate in an automatic locking open and closed mode as described above. Many different locking mechanisms may be utilized to provide an automatic locking open and closed mode. In one such exemplary embodiment, as shown schematically in FIGS. 4A and 4B, a padlock 20 includes a blocker 22 that holds locking members 25 in interlocking engagement with the shackle 23 (i.e., with notches in the shackle when the shackle is closed, and with the base of the shackle when the shackle is open) in a shackle engaging condition. The blocker 22 permits disengagement of the locking members 25 from the shackle 23 in a shackle disengaging condition to permit withdrawal or opening of the shackle 23. A blocker securing latch member 24 is movable between a locked condition (FIG. 4A) in which the latch member 24 blocks movement of the blocker 22 toward the shackle disengaging condition, and an unlocked condition (FIG. 4B) in which the latch member 24 permits movement of the blocker 22 to the shackle disengaging condition. Proper manipulation of a lock interface 26 (e.g., any of the exemplary mechanical or electromechanical lock interfaces described above) moves the latch member 24 from the locked condition to the unlocked condition, upon which the shackle 23 may be manually pulled to an open position or automatically moved to the open position (e.g., by a spring biasing mechanism), or manually or automatically moved to the closed position. To automatically lock the shackle 23 in both open and closed positions, a linking member 29 is connected to the blocker 22 and configured to move the latch member 24 from the unlocked condition to the locked condition when the blocker 122 moves from the shackle disengaging position to the shackle engaging position.

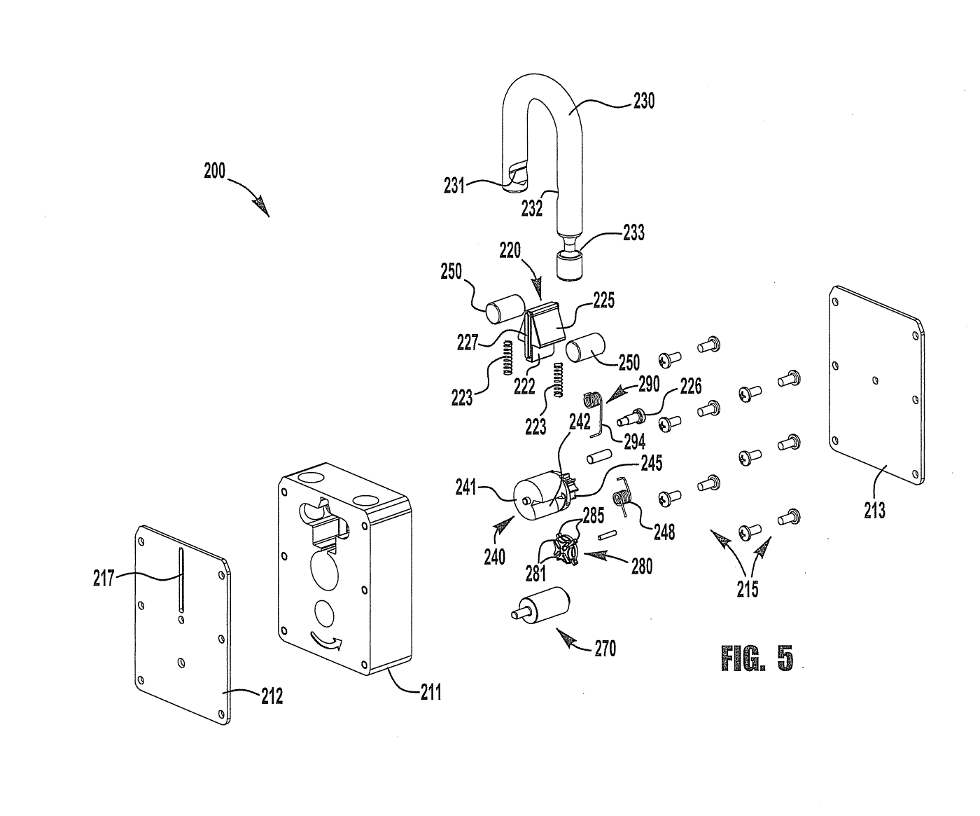

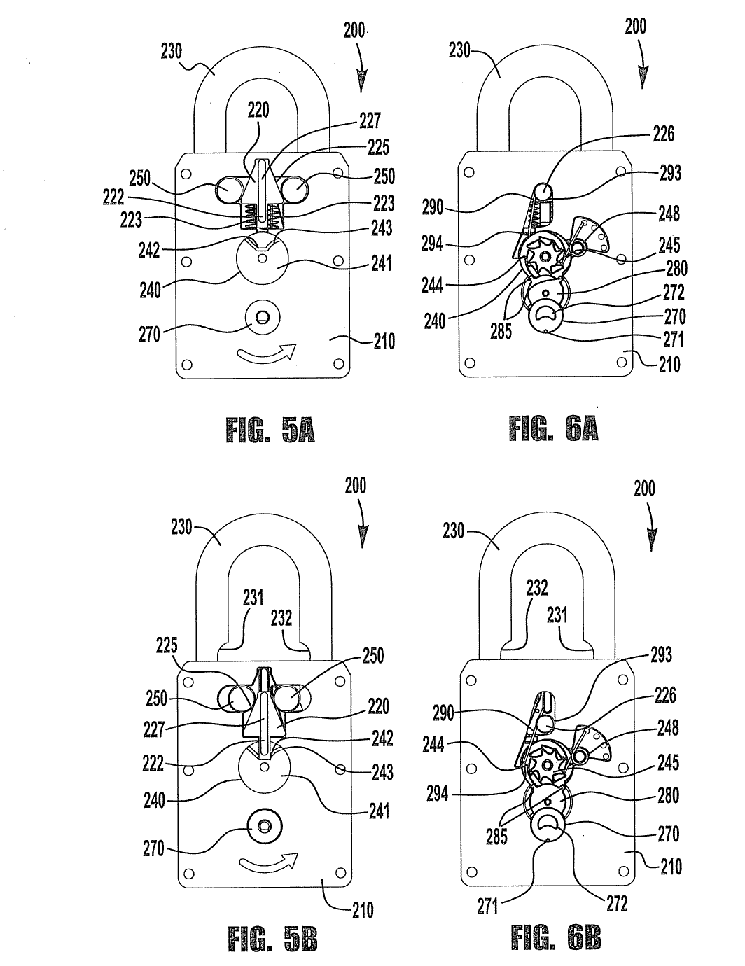

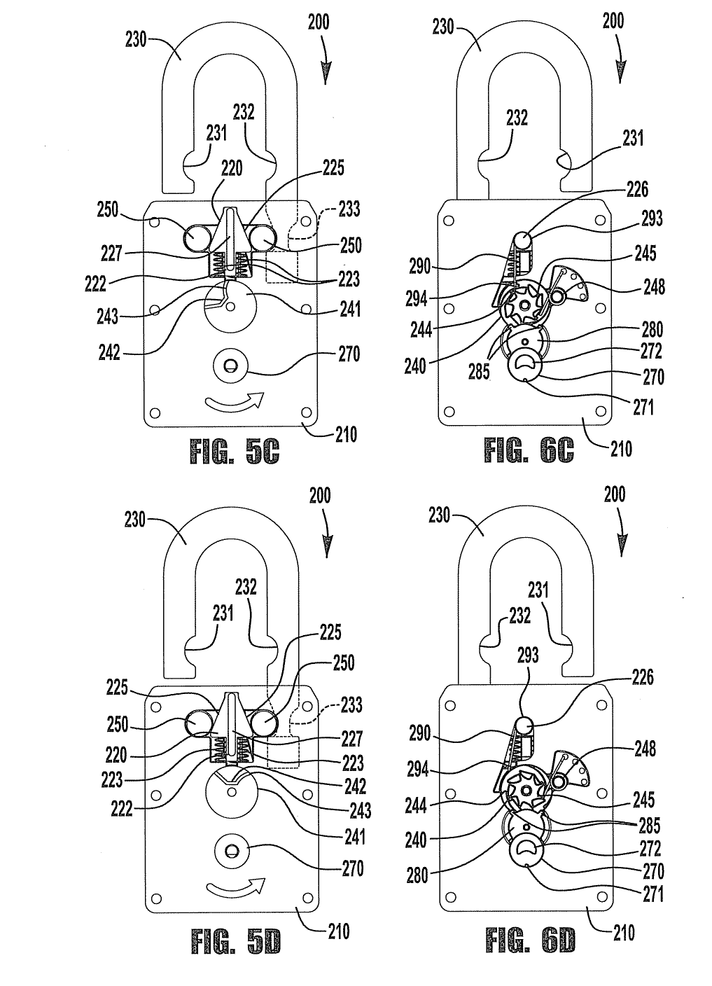

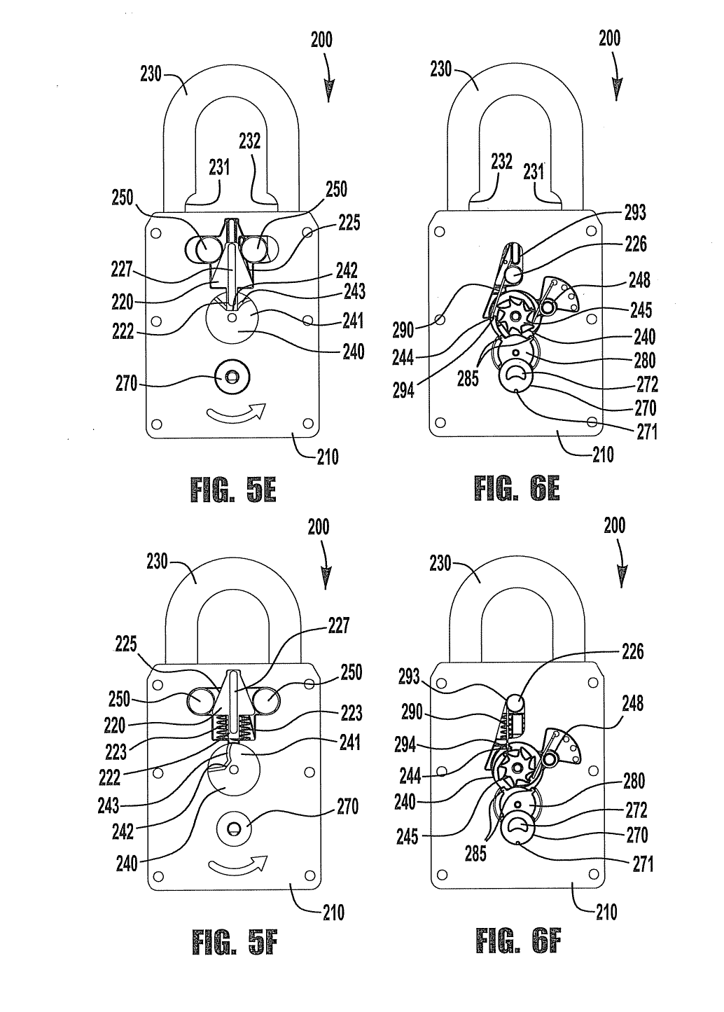

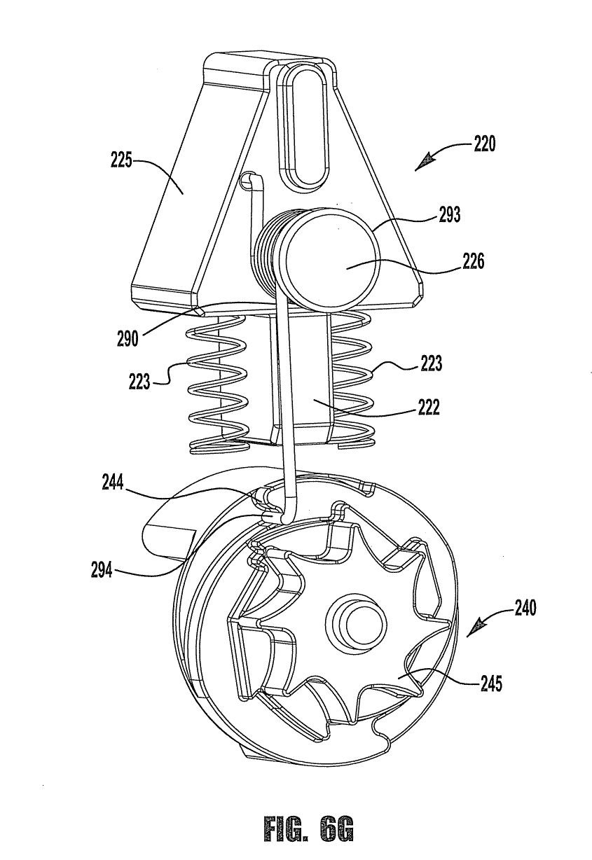

FIGS. 5, 5A-5F, and 6A-6F illustrate partial cross-sectional front and rear views of an exemplary padlock 200 with a locking mechanism providing for an automatic locking open and closed mode, as described above. The padlock includes a sliding blocker 220 spring-biased (by springs 223) toward a shackle engaging position (FIGS. 5A, 5C, 5D, and 5F), in which a wide portion of the blocker 220 holds locking pins 250 in interlocking engagement with shackle notches 231, 232 in the shackle's closed position, or with the shackle base (FIG. 5C) in the shackle's open position. A rotary latch member 240 includes an outer peripheral or raised locking portion 241 that secures the blocker 220 in the shackle engaging position when the rotary latch member 240 is in the locked position (FIGS. 5C and 5F). The rotary latch member 240 also includes a recessed unlocking portion 242 that aligns with the blocker 220 to permit movement of the blocker 220 from the shackle engaging position to a shackle disengaging position when the rotary latch member 240 is in an unlocked position (see FIGS. 5A, 5B, 5D, and 5E). In the latch member's unlocked position, upward or downward movement of the shackle 230 causes the locking pins 250 to force the blocker 220 downward into the unlocking portion 242 of the rotary latch 240 (i.e., into the shackle disengaging position), causing the locking pins 250 to disengage from the shackle 230 for release of the shackle. When the shackle reaches the fully open or fully closed position, the locking pin(s) 250 reengage the shackle base 233 (in the open position) or shackle notches (in the closed position), allowing the spring-biased blocker 220 to automatically return to the shackle engaging position.

To automatically lock the shackle 230 when the shackle is moved to the open and closed positions, in one embodiment, movement of the blocker 220 to the shackle disengaging position causes a linking member 290 operatively connected with the blocker 220 to engage the rotary latch 240, such that the linking member 290 advances the rotary latch to the locked position when the shackle 230 reaches the fully open or fully closed position and allows the blocker 220 to return to the shackle engaging position. In the exemplary embodiment, as shown in FIG. 6G, the linking member 290 is a torsion spring having a first end 293 connected with the blocker 220 (e.g., around pin 226 extending from the locker) and a second end 294 that engages an outer peripheral gear tooth 244 on the rotary latch 240 when the blocker 220 is moved to the shackle disengaging position. When the blocker 220 returns to the shackle engaging position, the blocker 220 and torsion spring 290 rotate the latch member 240 to the locked position (FIGS. 6C and 6F). To help urge the blocker 220 back to the shackle engaging position, an end surface 243 of the recessed portion 242 of the latch member 240 may be contoured for guiding engagement with the blocker extension 222.

Accordingly, both when the shackle 230 of the unlocked padlock 200 is pulled open (FIGS. 5B and 6B) and when the shackle is pushed closed (FIGS. 5E and 6E), the linking member 290 engages the latch member tooth 244. When the shackle 230 reaches the fully open position (FIGS. 5C and 6C) or the fully closed position (FIGS. 5F and 6F), the blocker 220 returns to the shackle engaging position (by force of biasing springs 223). The movement of the blocker moves the linking member 290 to rotate the latch member 240 a predetermined angle (e.g., 5-90 degrees, 30-60 degrees, or approximately 45 degrees) corresponding to the rotational distance between the unlocking portion 242 and locking portion 241 of the latch member 240 to move the latch member from the unlocked position to the locked position. In another embodiment (not shown), a padlock may be provided with motor driving circuitry that rotates the latch member from the unlocked position to the locked position in response to an indication that the blocker has returned to the shackle engaging position (e.g., using switches or other such sensors).

To unlock the padlock 200, the rotary latch member 240 is rotated from the locked position to the unlocked position. While any mechanism may be utilized to rotate the latch member to the unlocked position, in the illustrated embodiment, a motor 270 drives a gear 280, which in turn rotates the latch member 240 a predetermined angle (e.g., 270-360 degrees, 300-330 degrees, or approximately 315 degrees) corresponding to the rotational distance between the locking portion 241 and the unlocking portion 242 of the latch member 240 to move the latch member from the locked position to the unlocked position, similar to the embodiment of FIGS. 2, 2A-2C and 3A-3C, as described above.

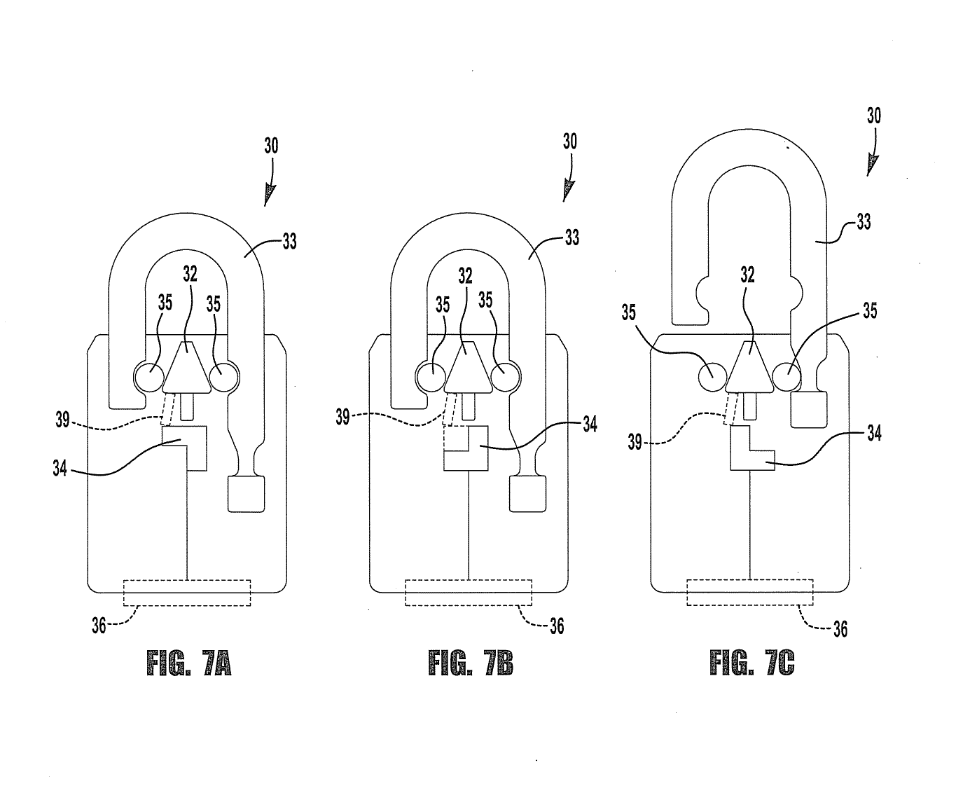

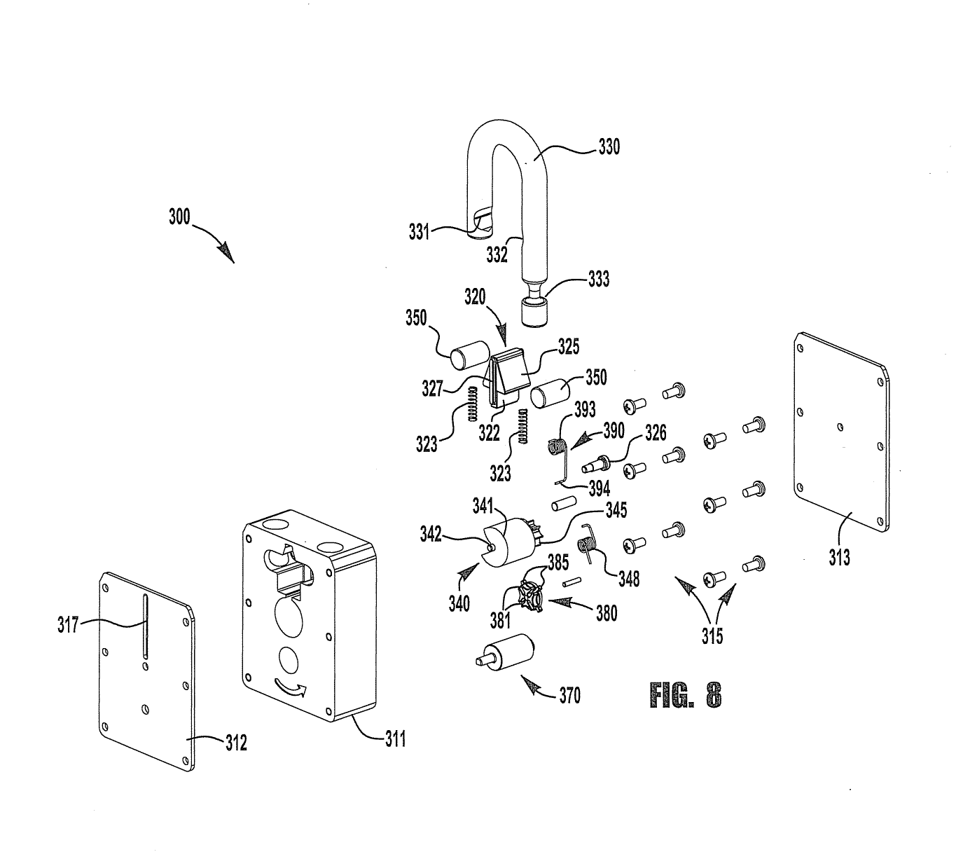

In still another exemplary embodiment, a padlock may be configured to operate in an automatic locking closed mode as described above. Many different locking mechanisms may be utilized to provide an automatic locking closed mode. In one such exemplary embodiment, as shown schematically in FIG. 7A, 7B, and 7C, a padlock 30 includes a blocker 32 that holds locking members 35 in interlocking engagement with corresponding notches in the padlock shackle 33 when in a shackle engaging condition, and permits disengagement of the locking members from the shackle notches in a shackle disengaging condition to permit withdrawal or opening of the shackle. A blocker securing latch member 34 is movable between a locked condition (FIG. 7A) in which the latch member blocks movement of the blocker 32 toward the shackle disengaging condition, and an unlocked condition (FIG. 7B) in which the latch member permits movement of the blocker 32 to the shackle disengaging condition. Proper manipulation of a lock interface 36 (e.g., any of the exemplary mechanical or electromechanical lock interfaces described above) moves the latch member 34 from the locked position to the unlocked position, upon which the shackle 33 may be manually pulled to an open position or automatically moved to the open position (e.g., by a spring biasing mechanism). To allow the padlock to automatically re-lock when the shackle is returned to the closed position, a linking member 39 is operatively connected to the blocker 32 and configured to move the latch member 34 from the unlocked position to the locked position when the blocker 32 moves from the shackle disengaging position to the shackle engaging position. As the blocker 32 is moved from the shackle disengaging position to the shackle engaging position both when the shackle 33 is moved to the open position and when the shackle 33 is moved to the closed position, the linking member 39 may be configured to advance the latch member 34 in two stages, from a first unlocked position (FIG. 7B) to a second unlocked position (FIG. 7C) when the shackle 33 is pulled to the open position, and from the second unlocked position to the locked position (FIG. 7A) when the shackle 33 is moved to the closed position.

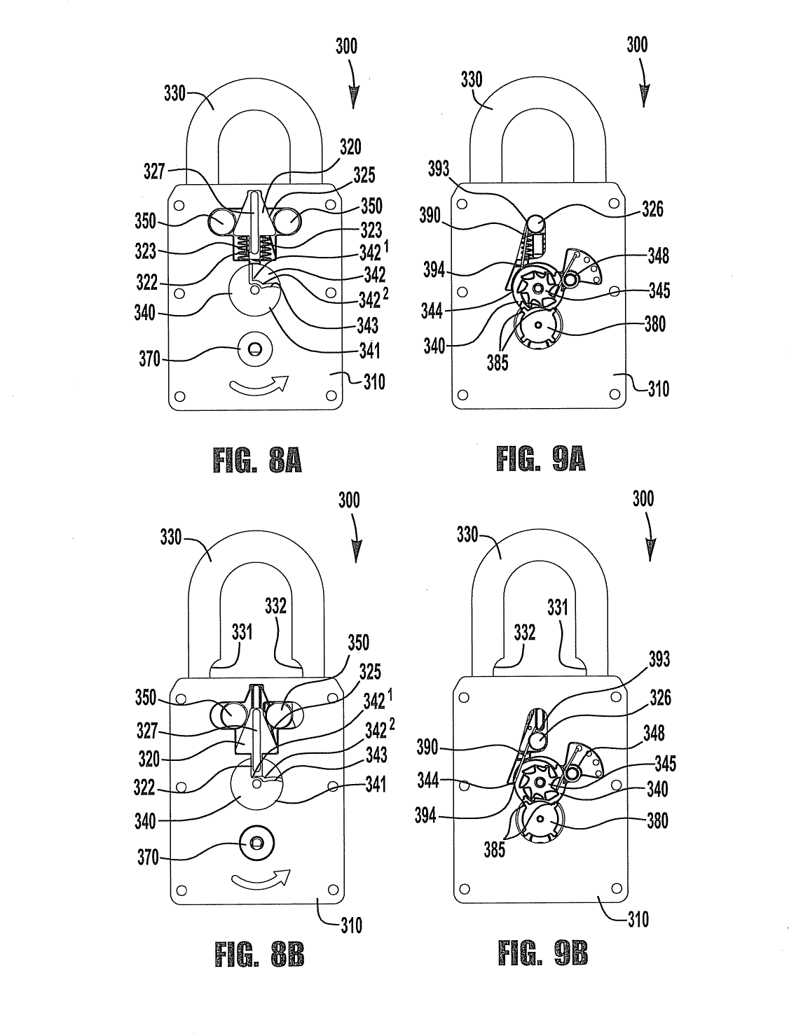

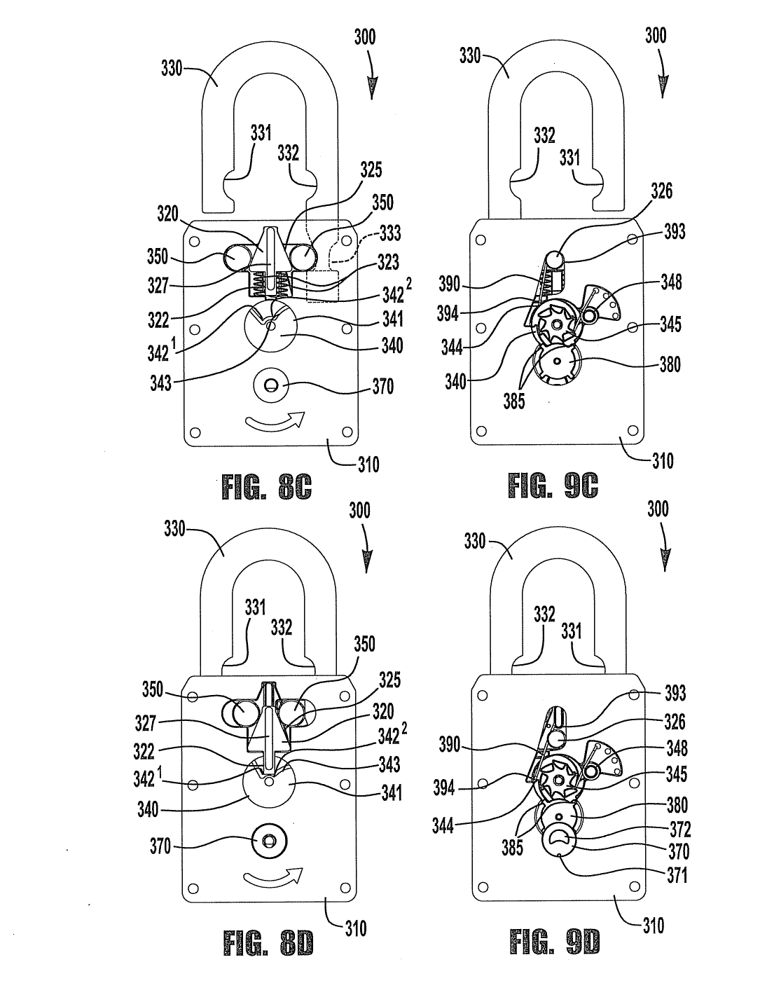

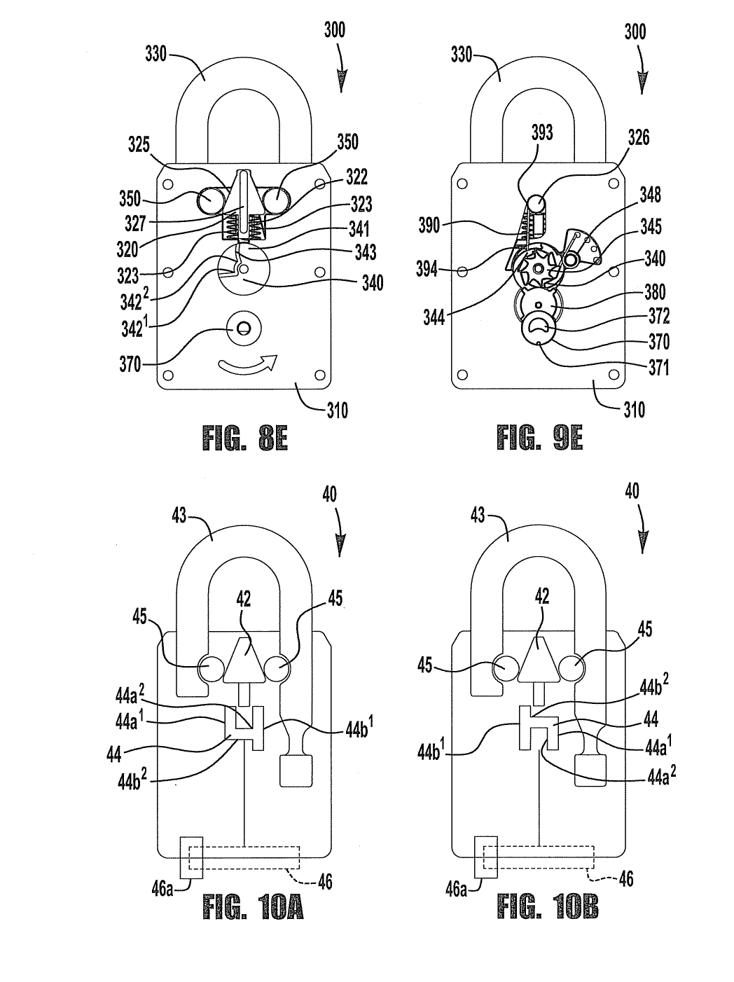

FIGS. 8, 8A-8E, and 9A-9E illustrate partial cross-sectional front and rear views of an exemplary padlock 300 with a locking mechanism providing for an automatic locking closed mode, as described above. The padlock 300 includes a sliding blocker 320 spring-biased (by springs 323) toward a shackle engaging position (FIGS. 8A, 8C, 8E), in which a wide portion of the blocker 320 holds locking pins 350 in interlocking engagement with shackle notches 331, 332 to secure the shackle 330 in a closed position. A rotary latch member 340 includes an outer peripheral or raised locking portion 341 that holds the blocker 320 in the shackle engaging position when the rotary latch member 340 is in the locked position (FIG. 8E). The rotary latch member further includes a recessed unlocking portion 342 that aligns with the blocker 320 to permit movement of the blocker from the shackle engaging position to a shackle disengaging position when the rotary latch member 340 is rotated to align the unlocking portion 342 with the blocker (see FIGS. 8A-8D). In the shackle disengaging position, upward movement of the shackle 330 causes the locking pins 350 to force a blocker extension 322 downward into the unlocking portion 342 of the rotary latch 340, causing the locking pins 350 to disengage from the shackle notches 331, 332 for release of the shackle 330. When the shackle is returned to the closed position, an end portion 35 of the long shackle leg drives the locking pin 350 against the tapered blocker surface 325 to move the blocker 320 to the shackle disengaging position. This arrangement allows the locking pins 350 to re-align with the shackle notches 331, 332, at which point the spring-biased blocker 320 automatically returns to the shackle engaging position.

To automatically lock the padlock 300 when the shackle 330 is returned to the closed position, in the exemplary embodiment, movement of the blocker 320 to the shackle disengaging position causes a linking member 390 operatively connected with the blocker 320 to engage the rotary latch 340, such that the linking member 390 advances the rotary latch to the locked position when the shackle 330 reaches the closed position and allows the blocker 320 to return to the shackle engaging position. As the blocker is also moved from the shackle disengaging position to the shackle engaging position when the shackle 330 is moved to the open position, the linking member 390 advances the latch member 340 in two stages, from a first unlocked position (FIG. 8A) to a second unlocked position (FIG. 8C) when the shackle 330 is pulled to the open position, and from the second unlocked position to the locked position (FIG. 8E) when the shackle 330 is moved to the closed position. In the exemplary embodiment, the linking member 390 is a torsion spring having a first end 393 connected with the blocker 320 and a second end 394 that engages a portion of the latch member 340 (for example, an outer peripheral gear tooth 344 on the latch member) when the blocker 320 is moved to the shackle disengaging position. When the blocker returns to the shackle engaging position, the blocker 320 and torsion spring 390 rotate the latch member 340 to the next sequential position.

Accordingly, when the shackle 330 of the unlocked padlock 300 is pulled open (FIGS. 8B and 9B), the linking member 390 engages a first gear tooth 344 on the latch member 340. When the shackle 330 reaches the fully open position (FIGS. 8C and 9C), the blocker 320 returns to the shackle engaging position (by force of biasing springs 323). The movement of the blocker 320 moves the linking member 390 to rotate the latch member 340 a predetermined angle (e.g., 5-90 degrees, 30-60 degrees, or approximately 45 degrees) corresponding to the rotational distance between a first recessed unlocking portion 342¹ and a second recessed unlocking portion 342² of the latch member 340 to move the latch member from a first unlocked position, in which the blocker extension 322 aligns with the first unlocking portion 342¹ of the latch member to a second unlocked position, in which the blocker extension aligns with the second unlocking portion 342² of the latch member. When the shackle 330 is pushed toward the closed position (FIGS. 8D and 9D), the linking member 390 engages a second gear tooth 344 on the latch member 340. When the shackle 330 reaches the fully closed position (FIGS. 8E and 9E), the blocker 320 returns to the shackle engaging position (by force of biasing springs 323). The movement of the blocker 320 moves the linking member 390 to rotate the latch member 340 a predetermined angle (e.g., 5-90 degrees, 30-60 degrees, or approximately 45 degrees) corresponding to the rotational distance between the second recessed unlocking portion 342² of the latch member 340 and the locking portion 341 of the latch member to move the latch member from the second unlocked position to the locked position, in which the blocker extension 322 aligns with the locking portion 341 of the latch member 340. To help urge the blocker 320 back to the shackle engaging position, an end surface 343 of the recessed portion 342 of the latch member 340 may be contoured for guiding engagement with the blocker extension 322.

To unlock the padlock 300, the rotary latch member 340 is rotated from the locked position to the first unlocked position. While any mechanism may be utilized to rotate the latch member to the first unlocked position, in the illustrated embodiment, a motor 370 drives a gear 380, which in turn rotates the latch member 340 a predetermined angle (e.g., 225-315 degrees, 255-285 degrees, or approximately 270 degrees) corresponding to the rotational distance between the locking portion 341 and the first unlocking portion 342¹ of the latch member 340 to move the latch member from the locked position to the first unlocked position, similar to the embodiment of FIGS. 2, 2A-2C and 3A-3C, as described above.

According to another inventive aspect of the present application, a lock may be configured to be selectively changeable to any of two or more operating modes, including for example, the unlocked open and closed mode, automatic locking open and closed mode, and automatic locking closed mode, as described above. In one such embodiment, as shown schematically in FIGS. 10A and 10B, a multiple mode padlock 40 may be provided with a latch member 44 having first mode locking and unlocking portions 44a¹, 44a² that align with a blocker 42 when the lock 40 is in respective locked and unlocked positions in a first mode, and having second mode locking and unlocking portions 44b¹, 44b² that align with the blocker 42 when the lock 40 is in respective locked and unlocked positions in a second mode. Additional locking and unlocking portions for additional lock modes may (but need not) also be provided on the latch member. To change the lock 40 to a selected one of the first and second (or more) modes, a mode selection mechanism 46a (which may, but need not, be provided with the lock interface 46) may be utilized to orient the locking and unlocking portions associated with the selected mode for operative engagement with the blocker 42. While a mode selection mechanism 46a may include a mechanical arrangement configured to control the orientation of the latch member, in another embodiment, the mode selection mechanism 46a includes an electromechanical arrangement operable by proper manipulation of an electronic lock interface (e.g., keypad entry, biometric scanner, remote signal transmission, electromagnetic key card interface, etc.). In an exemplary embodiment, an electromechanical mode selection mechanism includes circuitry configured to provide a signal to a motor (e.g., the motors of the exemplary embodiments described above) to rotate a latch member for alignment of one of the locking and unlocking portions corresponding to the selected mode with the blocker. The circuitry may further be configured to control rotation of the latch member 44 upon authorized operation of the lock 40 between locked and unlocked positions.

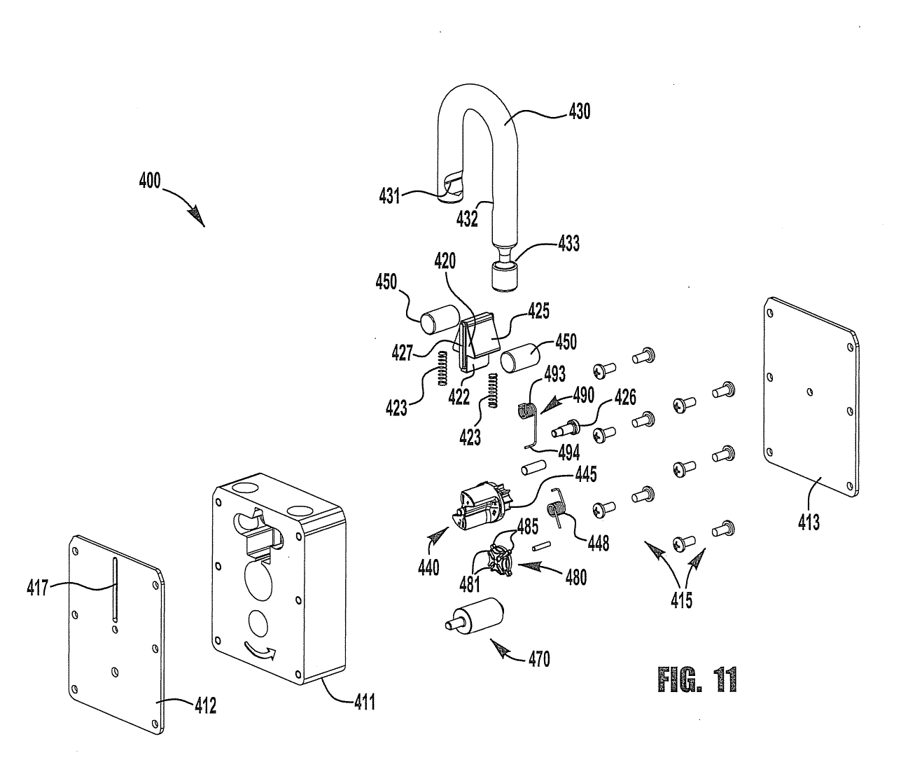

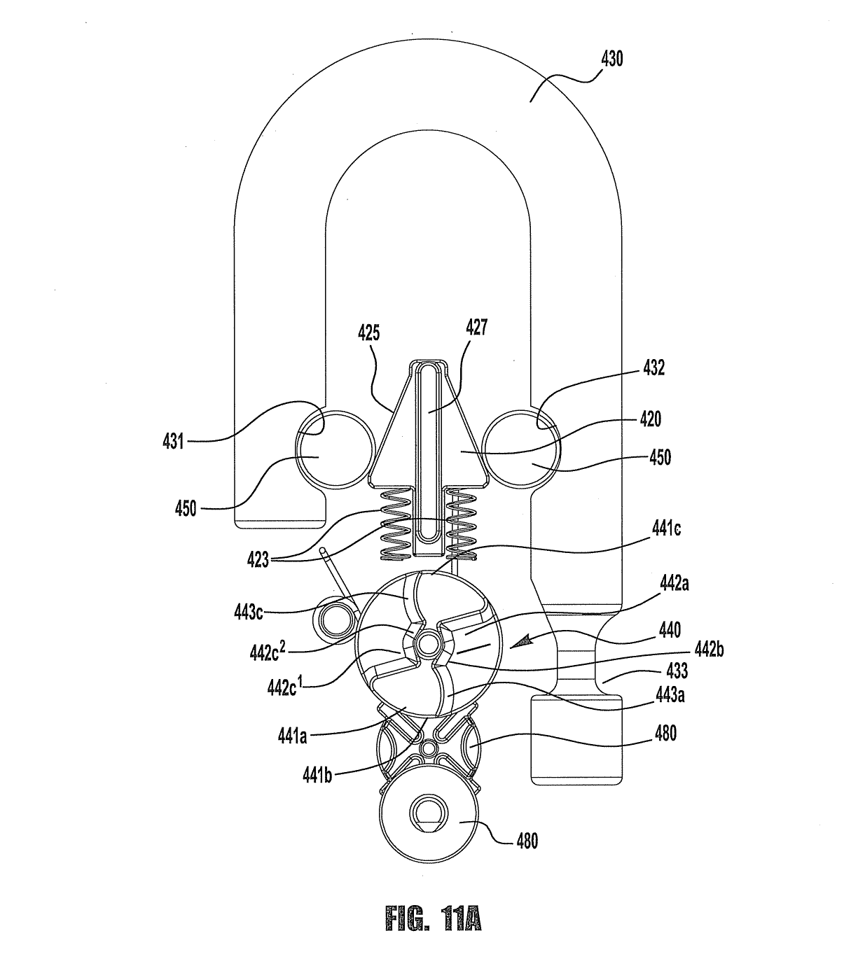

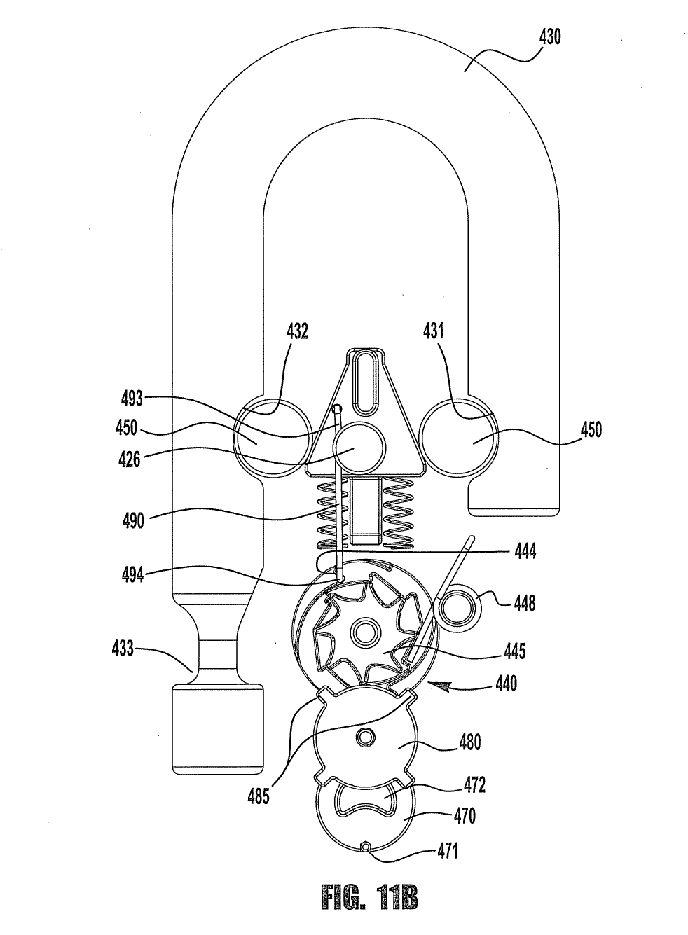

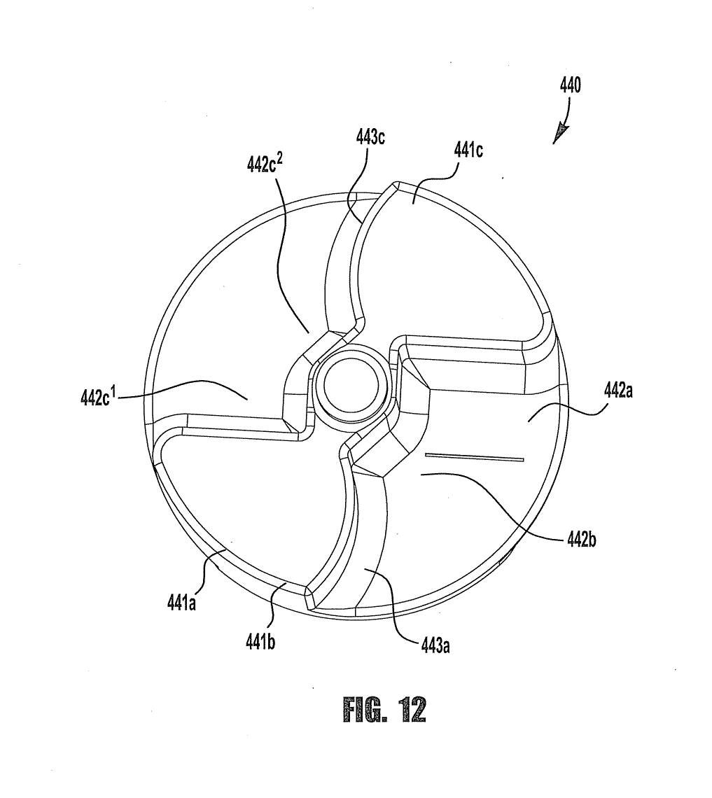

FIGS. 11, 11A, and 11B illustrate an exemplary multi-mode padlock 400 configured for selective operation in an “unlocked open and closed” first mode, an “automatic locking open and closed” second mode, and an “automatic locking closed” third mode, as described above. The padlock 400 includes a latch member 440 having first, second, and third mode locking portions 441a, 441b, 441c and first, second, and third mode unlocking portions 442a, 442b, 442c, which may, but need not, substantially correspond to the locking and unlocking portions of the latch members of the padlocks described above. As shown, the multi-mode padlock may include a locking mechanism substantially similar to that of the padlocks 100, 200, 300 described above.

When the padlock 400 is set to the unlocked open and closed first mode (e.g., by user input using an electronic lock interface), the motor 470 rotates the latch member 440 (via gear member 480) to one of the first mode locked and unlocked positions, aligning a corresponding one of the first mode locking portion 441a and the first mode unlocking portion 442a with the blocker extension 422. Subsequent operation of the lock 400 while in the first mode (e.g., by user input using an electronic lock interface) causes the motor 470 to rotate the latch member 440 (via gear member 480) between the first mode locked position and the first mode unlocked position, for operation of the lock 400 substantially as described above with respect to the padlock 100 of FIGS. 2, 2A-2C, and 3A-3C. In the illustrated embodiment, to prevent automatic advancement or rotation of the latch member 440 when the blocker 420 is returned to the shackle engaging position (as provided when operating in the second and third modes, as described below), the portion of the latch member 440 that aligns with the linking member when the latch member is in the unlocked position is provided without an outer peripheral gear tooth. This arrangement prevents engagement of the latch member 440 with the linking member 490, and the resulting automatic rotation of the latch member when the shackle 430 is pulled open or pushed closed.

When the padlock 400 is set to the automatic locking open and closed second mode (e.g., by user input using an electronic lock interface), the motor 470 rotates the latch member 440 (via gear member 480) to one of the second mode locked and unlocked positions, aligning a corresponding one of the second mode locking portion 441b and the second mode unlocking portion 442b with the blocker extension 422. Subsequent operation of the lock 400 while in the second mode locked position (e.g., by user input using an electronic lock interface) causes the motor 470 to rotate the latch member 440 (via gear member 480) from the second mode locked position to the second mode unlocked position, for operation of the lock 400 substantially as described above with respect to the padlock 200 of FIGS. 5, 5A-5F, and 6A-6F. As with the padlock of FIGS. 5A-5F and 6A-6F, movement of the shackle 430 to the fully open or fully closed position when the padlock 400 is set to the second mode causes the blocker 420 and linking member 490 to rotate the latch member 440 from the second mode unlocked position to the second mode locked position, for automatic locking of the shackle 430 in the open and closed positions.

When the padlock 400 is set to the automatic locking closed third mode (e.g., by user input using an electronic lock interface), the motor 470 rotates the latch member 440 (via gear member 480) to one of the third mode locked and unlocked positions, aligning a corresponding one of the third mode locking portion 441c and the third mode unlocking portion 442c with the blocker extension 422. Subsequent operation of the lock 400 while in the third mode locked position (e.g., by user input using an electronic lock interface) causes the motor 470 to rotate the latch member 440 (via gear member 480) from the third mode locked position to the third mode first unlocked position, for operation of the lock 400 substantially as described above with respect to the padlock 300 of FIGS. 8, 8A-8E, and 9A-9E. As with the padlock 300 of FIGS. 8, 8A-8E, and 9A-9E, movement of the shackle 430 to the fully open position when the padlock 400 is set to the third mode causes the blocker 420 and linking member 490 to rotate the latch member 440 from the third mode first unlocked position 442c¹ to the third mode second unlocked position 442c². Movement of the shackle 430 to the fully closed position when the padlock 400 is set to the third mode causes the blocker 420 and linking member 490 to rotate the latch member 440 from the third mode second unlocked position 442c² to the third mode locked position 441c. This arrangement provides for automatic locking of the shackle 430 in the closed position only.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, components, form, fit and function, etc.—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention.

1. A lock comprising:
a lock body;
an access restricting structure assembled with the lock body and movable with respect to the lock body between a first position and a second position;
a locking mechanism assembled with the lock body and movable between a locked condition and an unlocked condition, the locking mechanism being operable to secure the access restricting structure in the first position when the locking mechanism is in the locked condition;
a user operable lock interface assembled with the lock body, the lock interface being operable to move the locking mechanism between the locked condition and the unlocked condition; and
a user operable mode selection mechanism assembled with the lock body, the mode selection mechanism being operable to selectively place the locking mechanism in either one of a first mode and a second mode;
wherein when the locking mechanism is in the first mode, movement of the access restricting structure to the first position automatically moves the locking mechanism to the locked condition, and when the locking mechanism is in the second mode, the access restricting structure is movable to the first position without moving the locking mechanism to the locked condition.

2. The lock of claim 1, wherein the locking mechanism is further operable to secure the access restricting structure in the second position when the locking mechanism is in the locked condition;

3. The lock of claim 2, wherein the mode selection mechanism is further operable to place the locking mechanism in a third mode, wherein when the locking mechanism is in the third mode, movement of the access restricting structure to the first position automatically moves the locking mechanism to the locked condition to lockingly secure the access restricting structure in the first position, and movement of the access restricting structure to the second position automatically moves the locking mechanism to the locked condition to lockingly secure the access restricting structure in the second position.

4. The lock of claim 1, wherein the access restricting structure comprises a padlock shackle that is secured to the lock body in the first position and separated from the lock body in the second position.

5. The lock of claim 1, wherein the locking mechanism comprises a blocker that holds at least one locking member in interlocking engagement with the access restricting structure when the blocker is in a blocking position, the blocker being movable to a releasing position to permit disengagement of the at least one locking member from the access restricting structure when the locking mechanism is in the unlocked condition.

6. The lock of claim 5, wherein the locking mechanism further comprises a latch that secures the blocker against movement to the releasing position when the locking mechanism is in the locked condition and permits movement of the blocker to the releasing position when the locking mechanism is in the unlocked condition.

7. The lock of claim 6, wherein when the locking mechanism is in the first mode, movement of the locking mechanism from the locked condition to the unlocked condition comprises movement of the latch from a first locking position to a first unlocking position, and when the locking mechanism is in the second mode, movement of the locking mechanism from the locked condition to the unlocked condition comprises movement of the latch from a second locking position to a second unlocking position.

8. The lock of claim 7, further comprising a linking member connected with the blocker, wherein when the latch is in the first locking position and the blocker is in the releasing position, the linking member engages the latch, such that when the blocker returns to the blocking position, the linking member moves the latch to move the locking mechanism from the unlocked condition to the locked condition.

9. The lock of claim 8, wherein when the locking mechanism is in the second mode and the blocker is in the releasing position, the linking member is disengaged from the latch, such that when the blocker returns to the blocking position, the locking mechanism remains in the unlocked condition.

10. The lock of claim 6, wherein when the locking mechanism is in the first mode, movement of the locking mechanism from the locked condition to the unlocked condition comprises rotation of the latch from the first locking position to the first unlocking position in which a first recess portion of the latch aligns with the blocker to permit movement of the blocker from the blocking position to the releasing position, and when the locking mechanism is in the second mode, movement of the locking mechanism from the locked condition to the unlocked condition comprises rotation of the latch from the second locking position to the second unlocking position in which a second recess portion of the latch aligns with the blocker to permit movement of the blocker from the blocking position to the releasing position.

11. The lock of claim 10, further comprising a linking member separably connected between the blocker and the latch, wherein when the latch is in the first unlocking position and the access restricting structure is moved to the first position, movement of the blocker to the blocking position causes the linking member to rotate the latch to the first locking position, and further wherein when the latch is in the second unlocking position and the access restricting structure is moved to the first position, the linking member is disconnected from the latch, such that the latch remains in the second unlocking position.

12. (canceled)

13. The lock of claim 8, wherein the linking member comprises a spring member including a first end fixed to the blocker and a second end that engages a first gear tooth on the latch when the shackle is in the closed position and the blocker is in the releasing position, and that engages a second gear tooth on the latch when the shackle is in the open position and the blocker is in the releasing position.

14. The lock of claim 6, wherein the lock interface comprises an electronic interface configured to power a motor for rotation of the latch in response to an authorized user input.

15.-20. (canceled)

21. A multiple mode locking mechanism comprising:
a latch;
a user operable lock interface, operable in a first mode to selectively move the latch to provide a first lock condition, and operable in a second mode to selectively move the latch to provide a second lock condition; and
a mode selection mechanism operable to place the lock interface in a selected one of the first and second modes.

22. The locking mechanism of claim 21, wherein when the lock interface is in the first mode, the latch is movable between a first locking position and a first unlocking position, and when the lock interface is in the second mode, the latch is movable between a second locking position and a second unlocking position.

23. The locking mechanism of claim 22, further comprising a blocker, wherein the latch blocks movement of the blocker from a blocking position to a releasing position when the latch is in either one of the first and second locking positions, and the latch permits movement of the blocker from the blocking position to the releasing position when the latch is in either one of the first and second unlocking positions.

24. The locking mechanism of claim 23, wherein when the latch is in the first unlocking position, movement of the blocker from the releasing position to the blocking position automatically moves the latch to the first locking position, and when the latch is in the second unlocking position, movement of the blocker from the releasing position to the blocking position does not automatically move the latch to the second locking position.

25. The locking mechanism of claim 21, wherein the lock interface comprises an electronic interface configured to power a motor for movement of the latch in response to an authorized user input.

26. A method of operating a locking mechanism in a selected one of first and second lock modes, the locking mechanism including a latch operable between a locked position and an unlocked position and an access restricting structure movable between a first position and a second position, the method comprising:
operating a mode selection mechanism to selectively place the locking mechanism in a selected one of the first and second modes; and
moving the access restricting structure from the first position to the second position;
wherein when the locking mechanism is in the first mode, moving the access restricting structure to the second position automatically moves the latch to the locked condition to secure the access restricting structure in the second position, and when the locking mechanism is in the second mode, movement of the access restricting structure to the first position does not move the latch to the locked position.

27. The method of claim 26, further comprising operating a lock interface to move the latch from the locked position to the unlocked position prior to moving the access restricting structure from the first position to the second position.
